(19) United States
(12) Patent Application Publication
(10) Pub. No.: US 2021/0056410 A1
(43) Pub. Date: Feb. 25, 2021

(54) SENSOR DATA FORECASTING SYSTEM FOR URBAN ENVIRONMENT

(71) Applicant: Quantela Pte. Ltd., The Bencoolen (SG)

(72) Inventors: Sanjiv Kumar Jha, Bengaluru (IN); Arpana Alka, Bhagalpur (IN); Nikhil Vashishtha, Gaya (IN); Rohit Nair, Nagpur (IN); Rahul Agarwal, Kolkata (IN)

(21) Appl. No.: 16/663,221

(22) Filed: Oct. 24, 2019

(30) Foreign Application Priority Data
Jul. 19, 2019 (IN) 201941029307

(51) Int. Cl. G06N 3/08; G06Q 10/04; G06Q 30/02

(52) U.S. Cl. CPC G06N 3/08; G06Q 30/0205; G06Q 10/04

(57) ABSTRACT

A sensor data forecasting system for urban environment using deep learning model is provided. The system is configured to determine a false value by analyzing a time stamped and indexed sensor data received from a plurality of sensors in a location; determine a category of the false value by analyzing one or more of (a) historical sensor data (b) comparative sensor data between sensors of a first type and (c) comparative sensor data between sensors of the first type and a second type; determine an imputation method based on the category of the false value, wherein the imputation method uses one or more of (1) Kalman filter (2) a nearest neighbor value (3) a statistical analysis of repeating sensor values; impute the false value or determine an erroneous sensor; implement the Kalman filter, forecast sensor data based on the optimum sensor values at each data point by a trained Recurrent Neural Net (RNN) model and perform automation of tasks, using the processor, at the urban infrastructure based on the forecasted sensor data for urban management by generating commands at predetermined events or instances.

### BACKGROUND

### Technical Field

The embodiments herein generally relate to sensor data processing and more particularly, to a system and method for forecasting sensor data using a deep learning model.

### Description of the Related Art

In present times, urban environment is monitored to make its infrastructure smart using multiple sensors which are located at public places, for example ATM, banks, administrative areas, buildings, shopping, petrol station, airport, transport area, health care or hospital area, natural-geographical locations, rest areas, hang-outs, tourist sights, museums, restaurants etc. These sensors help in smart decision making and for automation of the city administration. These sensors may detect noise, environmental parameters, vehicles etc. to measure and monitor various infrastructure and operational aspects of a city.

At present, the sensors by themselves are not very reliable and have limitations due occurrence of error while measuring. Causes of error may be power cuts, Wi-fi connection loss, artifacts, manufacturing defects, environmental aspects such as dust etc. Further, lifespan of the functioning sensor is also not predictable in outdoor environment. To overcome these limitations, usually multiple sensors are deployed for automation and an estimation is made considering data from all sources. Existing solutions of data optimization are based on anomaly detection only. Anomaly detection may identify anomaly with respect to historical data of that sensor alone. Which is not sufficient to arrive at close, accurate or appropriate probable sensor values of a faulty sensor. Also, in existing systems it is not possible to identify the origin of the error. It is also not possible in existing approaches to suggest a correction value with less margin of error. Thus, human input is required to overcome the sensor errors and it is not possible to correct the faulty values with minimum margin of error by existing approaches.

Accordingly, there remains a need for comprehensive approach for predicting or forecasting the sensor data for automation in urban environment.

### SUMMARY

In an embodiment, a sensor data forecasting system that forecasts sensor data using a deep learning model is provided. The sensor data forecasting system includes a memory that stores a set of instructions and a processor that executes the set of instructions and is configured to generate a database of a time stamped and indexed sensor data, wherein the sensor data is received from a plurality of sensors of a plurality of sensor types implemented in a location, characterized in that, the processor is configured to (i) determine a false value by analyzing the time stamped and indexed sensor data, wherein the false value is determined based on predetermined parameters that comprise one or more of a constant value, an abnormally high or low value, a false value that is determined to be impossible or improbable, or a calibration error, (ii) determine a category of the false value by analyzing one or more of (a) historical sensor data of a first sensor, (b) comparative sensor data of the first sensor and a second sensor, and (c) comparative sensor data of one or more third sensors and the first sensor, wherein the first, second and third sensors are selected from the plurality of sensors, wherein the first sensor and the second sensor belong to a first sensor type of the plurality of sensor types and the one or more third sensors belongs to a second sensor type of the plurality of sensor types, (iii) determine an imputation method based on the category of the false value, wherein the imputation method employs one or more of (1) a Kalman filter, (2) a nearest neighbor value, (3) a statistical analysis of repeating sensor values of the plurality of sensors, (iv) impute the false value or determine an erroneous sensor from the plurality of sensors, (v) implement the Kalman filter that determines a sensor variance at each data point of the sensor data to generate optimum sensor value, (vi) forecast sensor data for a subsequent time stamps based on the optimum sensor values as determined at each data point by a trained Recurrent Neural Net (RNN) model, and (vii) perform automation of tasks at urban infrastructure based on the forecasted sensor data for urban management by generating commands at a predetermined events or instances as determined by the forecasted sensor data.

In some embodiments, the processor executed set of instructions are configured to (i) receive the sensor data from the plurality of sensors, wherein the plurality of sensor types comprises one or more of weather data, geo-profile and events data in the location and (ii) train the Recurrent Neural Net (RNN) model using the sensor data and the plurality of sensor types to identify a false value based on contextual understanding for each sensor type of the plurality of sensor types based on a user input.

In some embodiments, the processor executed set of instructions are configured to train the RNN model with one or more of (a) the sensor data of a time lag of a predetermined duration; (b) weather data that comprises the weather data comprises a temperature, a wind speed, a humidity, a presence or absence of rain, a presence or absence of clouds and luminosity, (c) a presence or absence of a predetermined point of interest that is analyzed using geo-profile of the location, (d) prescheduled events, or (e) determined cyclic events of weekdays or week-ends, days of a month and year.

In some embodiments, the processor executed set of instructions are configured to determine a false value indicating the constant value for predetermined threshold number of consecutive time-stamps specific to the sensor type by analyzing historical sensor data.

In some embodiments, the processor executed set of instructions are configured to determine the abnormally high or low value as determined by a predetermined threshold values specific to the sensor type.

In some embodiments, the processor executed set of instructions are configured to perform comparative sensor data analysis of the first sensor and a second sensor of the first sensor type indicates the false value that is determined to be impossible or improbable based on the sensor type.

In some embodiments, the processor executed set of instructions are configured to determine the calibration error based on constant higher or lower value readings for a sensor as determined by the comparative sensor data analysis.

In some embodiments, the processor executed set of instructions are configured to detect abnormal variance of the first sensor from the plurality of sensors by the comparative sensor analysis using Levene's test and the first sensor is indicated as an erroneous sensor.

In some embodiments, the processor executed set of instructions are configured to impute the sensor data by taking average of a particular time stamp of repeating sensor value trends over a period of time and replace a false value with the average value for the time stamp.

In some embodiments, the processor executed set of instructions are configured to impute the sensor data by replacing a false value by a nearest neighbor value using KNN algorithm.

In some embodiments, the processor executed set of instructions are configured to impute the sensor data by replacing the false value by an interpolation value, wherein the previous and subsequent time stamp values are processed to determine a mid-value for a data point of the false value.

In some embodiments, the processor executed set of instructions are configured to impute the sensor data by replacing the false value by an interpolation of at least two repeating sensor value trends over a period of time.

In another aspect, a method of forecasting sensor data at urban infrastructure using a sensor data forecasting system is provided. The method comprising steps of: generating a database of a time stamped and indexed sensor data, wherein the sensor data is received from a plurality of sensors implemented in a location, characterized in that, determining a false value by analyzing the time stamped and indexed sensor data, wherein the false value is determined based on predetermined parameters that comprise one or more of a constant value, an abnormally high or low value, a false value that is determined to be impossible or improbable, or a calibration error, determining a category of the false value by analyzing one or more of (a) historical sensor data of a first sensor, (b) comparative sensor data of the first sensor and a second sensor, and (c) comparative sensor data of third sensor and the first sensor, wherein the first, second and third sensors are selected from the plurality of sensors wherein, the first sensor and the second sensor belong to a first sensor type and the third sensor belong to a second sensor type, determining an imputation method based on the category of the false value, wherein the imputation method employs one or more of (1) a Kalman filter, (2) a nearest neighbor value, (3) a statistical analysis of repeating sensor values of the plurality of sensors, imputing, using the processor of the sensor data forecasting system, the false value or determine an erroneous sensor from the plurality of sensors, implementing the Kalman filter that determines a sensor variance at each data point of the sensor data to generate optimum sensor value, forecasting sensor data for a subsequent time stamps based on the optimum sensor values as determined at each data point by a trained Recurrent Neural Net (RNN) model and performing automation of tasks at the urban infrastructure based on the forecasted sensor data for urban management by generating commands at predetermined events or instances.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

FIG. 1 is a system diagram of a sensor data forecasting system that employs a deep neural network model according to an embodiment herein;

FIG. 2 is an exploded view of the sensor data server according to an embodiment herein;

FIG. 3 is a flow diagram depicting forecasting of sensor data using a deep neural network model according to an embodiment herein;

FIG. 4 is an exemplary graphical illustration of identifying a constant value anomaly according to an embodiment herein;

FIG. 5 is an exemplary graphical illustration of identifying an abnormal variance anomaly according to an embodiment herein;

FIG. 6 is an exemplary graphical illustration of identifying a spike anomaly according to an embodiment herein;

FIG. 7 is an exemplary graphical illustration of identifying an outlying value anomaly according to an embodiment herein;

FIG. 8 is an exemplary graphical illustration of identifying a calibration error of a sensor according to an embodiment herein;

FIG. 9A is an exemplary graphical illustration of raw sensor data according to an embodiment herein;

FIG. 9B is an exemplary graphical illustration of applying Kalman filter to raw sensor data according to an embodiment herein;

FIG. 10 is a block diagram of a sensor data forecasting system for forecasting the sensor data for a subsequent time stamp using deep neural net (RNN) model according to an embodiment herein;

FIG. 11 is an exemplary graphical interface view of forecasted sensor data using a deep neural net (RNN) model according to an embodiment herein;

FIG. 12 is an architecture view of RNN model integration with platform according to an embodiment herein; and

FIG. 13 is a representative hardware environment for practicing the embodiments herein is depicted in FIG. 8.

### DETAILED DESCRIPTION OF DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended mainly to facilitate an understanding of ways in which the embodiments herein may be practiced and to further enable those of skill in the art to practice the embodiments herein. Accordingly, the examples should not be construed as limiting the scope of the embodiments herein.

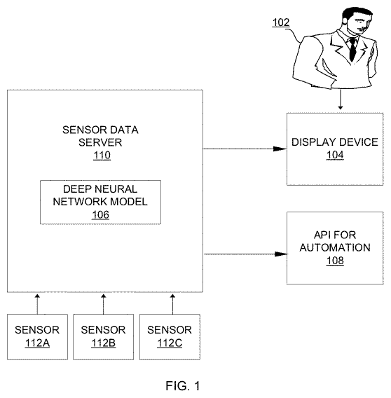

Various embodiments disclosed herein provide a sensor data prediction system and a method thereof. Referring now to the drawings, and more particularly to FIGS. 1 to 13, where similar reference characters denote corresponding features consistently throughout the figures, preferred embodiments are shown.

FIG. 1 is a system diagram of a sensor data forecasting system that employs a deep neural network model according to an embodiment herein. The system includes a sensor data server 110 which includes a deep neural network model 106. The sensor data server 110 is communicatively coupled to a display device 104 or to one or more web application programming interfaces (API) for automation 108. The sensor data server 110 receives data from a plurality of sensors, for example sensor 112A, sensor 112B and sensor 112C. The input from the plurality of sensors is processed through the sensor data server 110 for identifying value anomalies. The identified values are imputed and the deep neural network model 106 is used to forecast the sensor data for subsequent time stamps for one or more sensors 112A-C. The imputed and forecasted data is generated using the display device 104. User 102 has access to such imputed and forecasted data using the display device 104. Alternatively, the imputed and forecasted data is used for automation in urban environment. One example of such automation of tasks is controlling an indoor or an outdoor temperature in urban environment. Another example of such automation is urban waste management system. Another example of such automation of tasks is management of safety and healthcare in urban environment. Another example is crowd management or traffic management. Another example is disaster management and evacuation. It is time dependent data which is received from the urban environment at various urban infrastructures from sensors. So, the basic assumption of a linear regression model that the observations are independent doesn't hold in this case.

Along with an increasing or decreasing trend, most urban environment data have some form of seasonality trends, i.e. variations specific to a particular time frame. For example, if the sales of a woolen jacket over time are analyzed, there are higher sales in winter seasons than in summer season. Most of the sensor data is by nature time series data. For an urban environment, the sensor data is not only not independent, but they are also dependent on various other dynamic factors. For example, a typical set of contextual data are weather, events, week days, weekends, vacations, point of interests in that location like hospitals, schools.

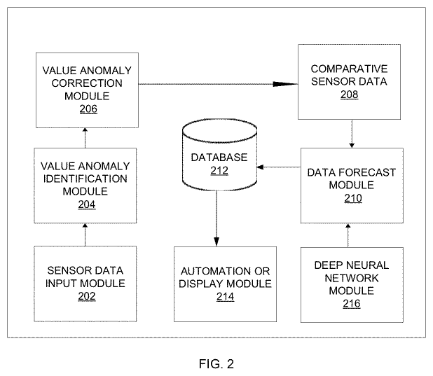

FIG. 2 is an exploded view of the sensor data server 110 according to an embodiment herein. The sensor data server 110 includes a sensor data input module 202, a value anomaly identification module 204, a value anomaly correction module 206, a comparative sensor data module 208, a data forecast module 210, a database 212, an automation or display module 214 and a deep neural network module 216. The sensor data input module 202 receives data from the plurality of sensors, for example 112A, 112B and 112C. The value anomaly identification module 204 identifies incorrect or erroneous value through a set of multiple analysis. The value anomaly correction module 206 corrects the incorrect or erroneous value by a set of imputation steps to arrive at smooth and corrected data which is then passed through contextual correction filter of values by the comparative sensor data module 208. The corrected and filtered values are analyzed by the data forecast module 210 using deep neural network model 106 and sensor data predictions are made for the subsequent time stamps. The deep neural network module 216 stores the deep neural network model 106. The automation or display module 214 displays the forecasted senor data and performs automation of the task based on the forecasted senor data.

In some embodiments, multiple sensor domains are identified. A threshold value is determined specific to a domain of a sensor. The sensor 112 may be determined to be erroneous if the sensor data continuously or intermittently shows values that cross the predetermined threshold. In some embodiments, a false value is identified based only on historical data analysis of a sensor over a period of time. In some embodiments, a false value is identified based on comparative analysis of multiple sensors from the same sensor type. The sensor type may be a location or type of the sensor based on the sensor data the sensor transmits or the mechanism of collecting or transmitting the sensor data. In some embodiments, a false value is identified based on cross domain contextual understanding of sensor data. For example, waste bin fill rate pattern is different for a bin outside restaurant compared to other bins in same location. Also, bin fill rate is high in the evening compared to morning of a day. Another example is waste bins outside cinema halls may fill when shows start or end. Presence or absence of restaurant, cinema hall, school etc. changes the waste bin fill rate and that is identified and used for forecasting of bins filling in urban waste management system.

In some embodiments, the nearest neighbor sensor values are used to impute. In an embodiment, KNN is an algorithm that is used for matching a point with its closest k neighbors in a multi-dimensional space. KNN may be used for data that is continuous, discrete, ordinal and categorical which makes it useful for dealing with all kind of missing data. The reason for using KNN for missing values is that a point value can be approximated by the values of the points that are closest to it, based on other variables.

In some embodiments, Kalman filters is used for imputing sensor values based in previous timestamp. Kalman filter operates on state-space models of the form, details of it are as explained elsewhere herein.

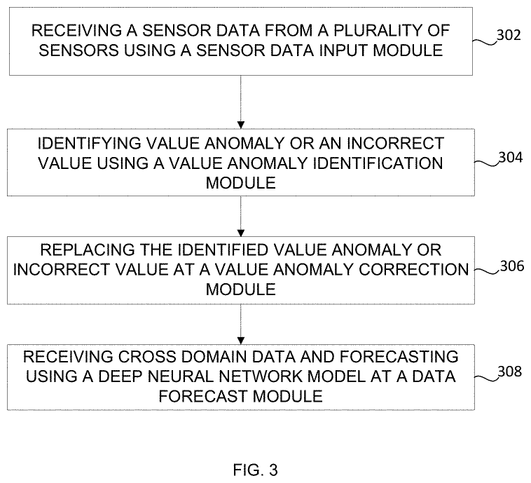

FIG. 3 is a flow diagram of a method of forecasting of sensor data using deep neural network model according to an embodiment herein. At step 302, a sensor data is received from a plurality of sensors using the sensor data input module 202. At step 304, a value anomaly or an incorrect value is identified using the value anomaly identification module 204. At step 306, the identified value is replaced at the value anomaly correction module 206. At step 308, cross domain data is received and the sensor data is forecasted using the deep neural network model 216 and the data forecast module 210. Various methods of identifying value anomaly and correction of values are described in an exemplary algorithm herein.

1. data_raw = Read Raw sensor Data

#Read sensor data (includes sensor ids, location, value from each sensor)

2. data_location = Extract altitude and latitude for each sensor from data_raw
3. data = modify data_raw
#Make sensor value data (sensor ids as columns)
4. Call Generate_report( )

Generate_report (data, data_location):

1. data_ smoothen, data_ null, data_ spikes = process_data (data, data_location, True)
2. list_notWorkingSensor = get_notWorkingSensor(data_null)
#Get Not working sensors = sensor whose values are all null.
3. Dict_outlier = get_outlierIndex (data_ smoothen, std_allowedFactor,
dayToConsider, range_permissible)
#Get Outlier index and its value
4. Dict_spikes = get_spikesIndex(spikes_data, dayToConsider)
#Get Spikes index and its value
5. Dict_abnormalVariance: get_abnormalVariance (alpha, data_smoothen,
dayToConsider)
#function to get dictionary of abnormal variance index and value
6. Dict_calibrationSensor: get_calibrationSensorID(data_ smoothen,
calibration_thershold, dayToConsider)
#call calibration function to get calibrated sensor ids.
7. Dict_output = dictionary of sensorids and value from above dictionary.
8. Save dict_output
# this is final output.

process_data(data, data_location,train=False)):

1. If nan in data_location:
Raise error
2. If not train:
Data_smoothen_past = Read saved Data_smoothen
Data_null_past = Read saved Data_null
Data_location_past = Read saved Data_location
If data > 7 days:
Data_combined = combine data and last 2 hour(Data_smoothen_past)
# last 2 hour(Data_smoothen_past ) = Data_smoothen_past[−2:]

Else:

Data_combined = combine data and Data_smoothen_past

Data_location_combined = inner join of data_location and data_location_past

3. Matrix_distance = distance between all sensors
4. Read domain_type, use_neighbor, sigma_threshold from input file
5. smoothen data, spikes data, null data = imputation(data_combined,
data_location_combined, matrix_distance, domain_type, use_neighbor,
sigma_threshold, default_value)
#Call get_imputed function to get imputed smoothen data, spikes data, null data.
6. Return data_ smoothen, data_ null, data_ spikes

get_notWorkingSensor (data_ null)

1. Initialize list blank_sids = [ ]
2. Loop column of null_data
If null_data[column] = all nan:

add it to blank_sids list

3. return blank_sids

get_outlierIndex (data_ smoothen, std_allowedFactor, dayToConsider,

range_permissible = None):

1. data_ smoothen = drop blank sensor ids columns from data
2. data_out= data_smoothen
3. initialize dictionary output = { }
4. mean = mean of data_smoothen
5. std = std of data_smoothen
6. data_ smoothen = select data of last dayToConsider
7. loop i, j for sensor id and length of data
8. if range_permissible is not None:
if data[i][j] not in range_permissible:
data_out[i][j] = True #data point is outlier
else:

data_out[i][j] = False #data point is not outlier

9. else
if data[i][j] in between std_allowedFactor *std + or − mean:
data_out[i][j] = True #data point is outlier
else:

data_out[i][j] = False #data point is not outlier

10. output = dictionary of sensor ids and index and value of outlier
#Make output dictionary of index and value from above step
11. Return output

get_spikesIndex (data_ spikes, dayToConsider):

1. data_ spikes = drop blank sensor ids columns from data_spikes
2. initialize dictionary sid_spikes= { }
3. data_ spikes = select data of last dayToConsider
4. loop for all sensor in above data
sid_spikes = Make sid_spikes dictionary of index and value from data_spikes
5. Return sid_spikes

get_calibrationSensorID(data_ smoothen, calibration_thershold,

dayToConsider): 1. data_ smoothen = drop blank sensor ids columns from data_ smoothen

```
2. initlialize dictionary dict_calibration = { }
3. data_ smoothen = select data of last dayToConsider
4. if number of sensors > 1
  proceed
Else
Return
5. data_ smoothen = Replace data values row wise by their percentile value.
6. Loop for each sensor values :
Average_percentile = find average of percentile value for a sensor
If average percentile > calibration_thershold then:
dict_calibration[sensor id] = high
If average percentile < calibration_thershold then:
dict_calibration[sensor id] = low
else :
  dict_calibration = none
7. return dict_calibration
```

imputation(data, distance_matrix, domain_type,

use_neighbor,sigma_threshold,default_value, repeated_allowed):

1. data_null = make_dataNull(data, default_value, repeated_allowed, minvalue) #If
value is null then it will be 1 else 0 at any particular index.
2. data_null = Transpose data_null
3. To fill nan values, given above data_null and distance matrix
a. if use_neighbor : #neighbors present for any sensor
data_null[sensor id] = use neighbor sensor value to impute value
a. to get neighbour sensor check for least distance working sensor
b. If domain type shows trend on daily basis then:
fill values by mean of hours
c. If domain type doesn't show trend on daily basis then:
use below step to impute
a. Interpolate on daily data and add fluctuation using hour data
b. Return imputed data.
4. data_smoothen = Apply smoothening technique to get smoothen data
5. do below steps to data_ spikes
1. data_spikes = data
2. mean = mean of data_smoothen
3. variance = mean of data_smoothen
4. data_smoothen_processed = Standardizes data_smoothen using mean and variance
5. i = loop for sensors of data_smoothen_processed
j= loop for each row
If data_smoothen_processed[i][j] > sigma_threshold:
Data_spikes = True

Else:

Data_spikes = False

6. Return data_spike
6. data_smoothen = Remove null sensor columns from data_smoothen
7. return smoothen data, spikes data and null data

make_dataNull(data, default_value, repeated_allowed, minvalue):

1. i = Loop for all sensors:
j = Loop for each value
if data[i][j] = default_value :
#if value is equal to default value than make it null
data[i][j] = none
if data[i][j]< minvalue :
#if value is less than values of sensor then make it null
data[i][j] = none
if data[i][j] = data[i][j−1] and repeat > repeated_allowed:
#if value is repeated more than repeated_allowed number given by user then make it
null
data[i][j] = none
2. return data

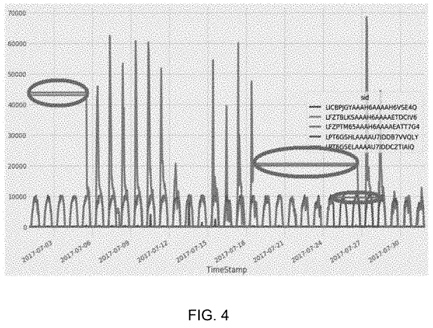

FIG. 4 is an exemplary graphical illustration of identifying a constant value anomaly according to an embodiment herein. In some embodiments, when the sensor 112 provides a constant or an exact same value for multiple consecutive timestamps, malfunctioning of the sensor 112 is identified. This value anomaly is dependent on the category or location of the sensor 112. The malfunctioning sensor is identified by comparing historical sensor data of the same sensor over a predetermined period of time.

In some embodiments, threshold values are predetermined for a domain or a type of a sensor. The value anomaly identification module 204 records a number of continuous reoccurrence of the sensor value and if the number of re-occurrences of the sensor value is more than the predetermined threshold for a given type of sensor 112, it is identified as constant value anomaly data point. The time period for which the getting constant value is acceptable and is dependent on the domain. For example, getting the same parking occupancy for few hours is acceptable but getting the exact same value of environment temperature for long hours indicates the malfunctioning of the sensor 112.

In some embodiments, the value anomaly correction module 206 removes all the identified constant value anomaly data points and replaces them with different methods of correction. In some embodiments, a nearest neighbor sensor value replaces the identified constant value anomaly data points.

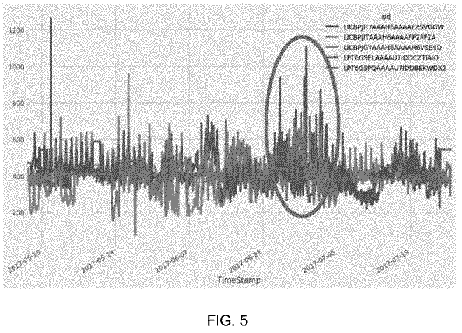

FIG. 5 is an exemplary graphical illustration of identifying an abnormal variance anomaly according to an embodiment herein. Generally, the sensor data values have some variance. The variance is composed of domain natural variance and some sensor errors. Sometimes sensor errors become so huge that it overshadows the natural variance. In some embodiment, the features of normal variance from all sensors performance over a predetermined period are captured. Then the features may be compared with the variance of a sensor using Levene's test. In an embodiment, the threshold p-value chosen is 0.0001 from experimentation. Once identified, the corresponding sensors are determined to be faulty sensors.

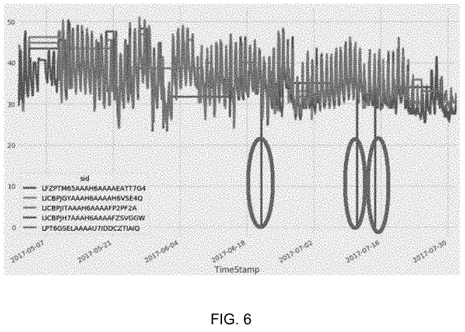

FIG. 6 is an exemplary graphical illustration of identifying a spike anomaly according to an embodiment herein. Sometimes, the sensor 112 provides abnormally high or low value from its previous time stamped values. Also, in next time stamps, it again comes back in range of standard deviation for that sensor 112. In some embodiments, the value anomaly identification module 204 identifies them as the spike anomaly by comparison of the spiked values with its moving average with respect to its standard deviation, which is determined by applying a Kalman Filter. In some embodiment, value out of 3 sigma range is considered a spike anomaly.

In some embodiments, the value anomaly correction module 206 removes all spike anomaly values. In some embodiments, the value anomaly correction module 206 imputes the spike anomaly using Kalman filter. For example, if domain does not have drastic change in values Kalman filter is applied to the entire time range of the sensor data. Kalman filter provides the optimal estimates of the states for t=1, 2 . . . , T. for example, imputation of temperature sensor data.

In some embodiments, when the values are of high variance and following a repeating trend, an average of the particular time frame is taken, and that value is used to correct the missing value. For example, values following a daily trend, average of each hour is taken and the value anomaly correction module 206 imputes the value to the unavailable hour using the historical average for the unavailable hour.

In some embodiments, the values do not follow any repeating trend, so the value anomaly correction module 206 uses interpolation to impute the value. The previous and after time stamped value of the sensor is used to find the average of mid unknown sensor value.

In an embodiment, if the values have hourly cyclicity and daily trend, the value anomaly correction module 206 uses interpolation on daily trend and overlays it with the variance of hourly cycle.

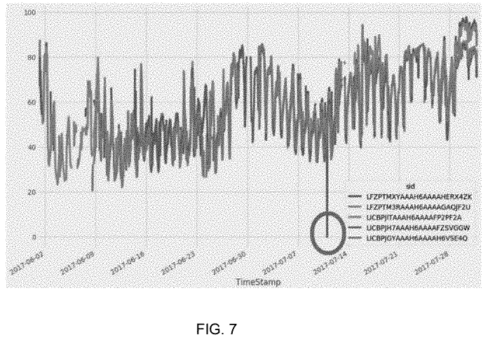

FIG. 7 is an exemplary graphical illustration of identifying an outlying value anomaly according to an embodiment herein. The outlying value is identified by the value anomaly identification module 204 as values which are either not possible for a particular sensor type or very far from a normal range boundary. For example, is not possible to negative parking occupancy and also the temperature value of 72 degrees Celsius is false where the range of temperature is from 15 degrees to 25 degrees Celsius. Identification of the outlying value anomaly is based on analysis of combination of sensor type and statistical computation. If a value lies outside the normal range boundary than it is considered as the outlying value anomaly.

In some embodiments, 3 to 5 sigma standard deviation is used to set the normal range boundary.

In some embodiments, the value anomaly correction module 206 imputes the outlying value anomaly using the Kalman filter. For example, if domain does not have drastic change in values Kalman filter is applied to the entire time range of the sensor data. Kalman filter gives the optimal estimates of the states for t=1, 2 . . . , T. Imputing data is via the measurement equation yt=Zαt+ε, εt˜N(0,H) as mentioned elsewhere herein, for example, imputation of temperature sensor data.

In some embodiments, when the values are of high variance and following a repeating trend, an average of the particular time frame is taken, and that value is used to correct the missing value. For example, values following a daily trend, average of each hour is taken and the value anomaly correction module 206 imputes the value to the unavailable hour using the historical average for the unavailable hour.

In some embodiments, the values do not follow any repeating trend, so the value anomaly correction module 206 uses interpolation to impute the value. The previous and after time stamped value of the sensor is used to find the average of mid unknown sensor value.

In an embodiment, if the values have hourly cyclic and daily trend, the value anomaly correction module 206 uses interpolation on daily trend and overlays it with the variance of hourly cycle.

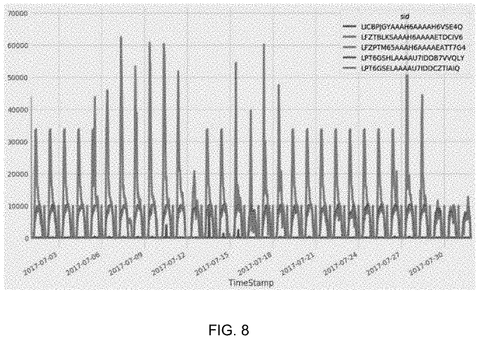

FIG. 8 is an exemplary graphical illustration of identifying calibration error of a sensor according to an embodiment herein. This graphical illustration depicts a comparison between the different sensor values. In some embodiments, the value anomaly identification module 204 compares the values of the sensor 112 which follows a pattern when individual sensor is analyzed. But, it is identified to be either very high or low range values. For example, if the all sensor value ranges in 0 to 100 and value given by the sensor is 0 to 20 or 80 to 100 while value given by most of the other sensors are in range 0 to 100 then it is classified as a case of low or high calibration respectively.

In some embodiments, to find calibration error, the value anomaly identification module 204 ranks the sensor based on values for each timestamp and then aggregate all rankings by the sensor 112. In an embodiment, if the aggregated ranking lies outside the range of 10 to 90, the sensor 112 is determined to be faulty.

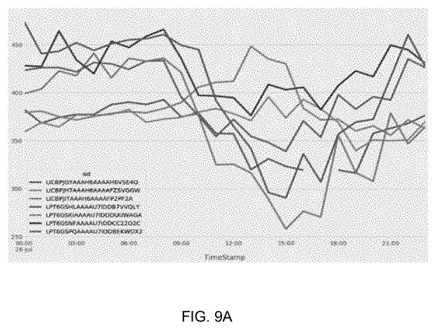

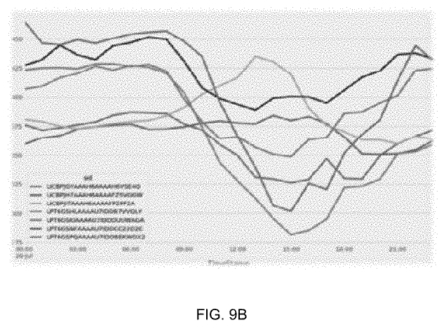

FIG. 9A is an exemplary graphical illustration of raw sensor data according to an embodiment herein. Each line on the graph represents reading of one or more sensor plotted against the time.

FIG. 9B is an exemplary graphical illustration of applying Kalman filter to raw sensor data according to an embodiment herein. In an embodiment, the Kalman filter operates on state-space models of the form,

yt=Zαt+ε εt˜N(0,H)

αt1=Tαt+ηt ηt˜N(0,Q)

α1˜N(a1,P1)

where yt is the observed series (possibly with missing values) but at is fully unobserved. The first equation (the “measurement” equation) says that the observed data is related to the unobserved states in a particular way. The second equation (the “transition” equation) says that the unobserved states evolve over time in a particular way.

The Kalman filter operates to find optimal estimates of at (at is assumed to be Normal: αt˜N(at,Pt), so what the Kalman filter actually does is to compute the conditional mean and variance of the distribution for at conditional on observations up to time t).

In the typical case, (when observations are available) the Kalman filter uses the estimate of the current state and the current observation yt to do the best it can to estimate the next state αt+1, as follows:

at+1=Tat+Kt(yt−Zαt)

Pt+1=TPt(T−KtZ)′+Q

where Kt is the “Kalman gain”.

When there is no observation, the Kalman filter may compute at+1 and Pt+1 in the best possible way. Since yt is unavailable, the Kalman filter cannot make use of the measurement equation, but it can still use the transition equation. Thus, when yt is missing, the Kalman filter instead computes:

at+1=Tat

Pt+1=TPtT′+Q

Essentially, the imputation module determines that given αt, the most probable interpretation is as to αt+1 without data is just the evolution specified in the transition equation. Imputation can be performed for any number of time periods with missing data.

If there is data yt, then the first set of filtering equations take the most probable value determined at missing data time stamp, and correct the value by a number based on correctness of the previous estimate as determined.

Once the Kalman filter has been applied to the entire time range, you have optimal estimates of the states at, Pt for t=1, 2, . . . , T. Imputing data is then simple via the measurement equation. In particular, you just calculate:

ŷt=Zat

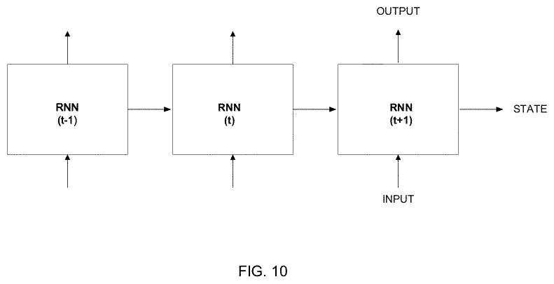

FIG. 10 is a block diagram of a sensor data forecasting system for forecasting of the sensor data for a subsequent time stamp using deep neural net (RNN) model according to an embodiment herein. RNN model is trained for a predetermined period to forecast data for different type or locations of sensors. historical data of each sensor, neighbor sensor data and cross domain understanding of sensor data filters unwanted false values and various imputation methods impute the false values to be replaced by the most relevant sensor values, also smoothing the data to arrive at sensor values for subsequent time stamps.

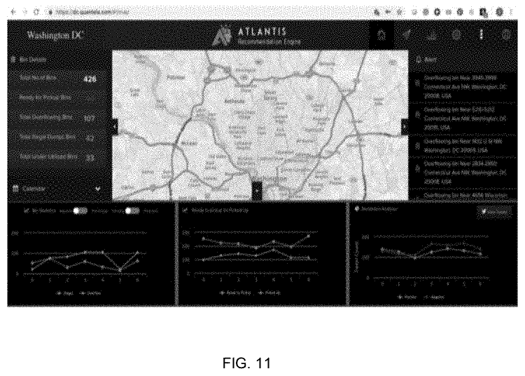

FIG. 11 is an exemplary graphical interface view of forecasted sensor data using a deep neural net (RNN) model according to an embodiment herein. The graphical interface view illustrates an example of waste collection system in Washington, D.C. area. Bins are attached with sensors to monitor filling, overflowing and picked up or emptied bins. The graphical interface view represents a total number of bins, ready to pick up bins, total overflowing bins, total illegal dump bins, total underutilized bins on top left side with color coding. The color-coded forecasted maps of overflowing versus illegal, ready to pick up versus picked up, sentimental analysis map based on social media analysis pertaining to waste management in the area are represented on bottom left, middle and right side of the graphical interface view. The graphical interface view represents map indicating bins location and an alert feature for overflowing bins with GPS determined address by RNN forecasted sensor data for the next time stamps. In an embodiment, the RNN model is trained taking into account time taken for each bin to fill up, historical data of emptying of bins, that of neighboring bins, other time dependent factors such as time of the day weekdays or weekends, festivals, holidays, tourist season etc., location dependent factors such as presence of restaurants, schools, public places etc., environmental factors for example, rain or sunshine, temperature and the sensor data is imputed when determined to be a value anomaly.

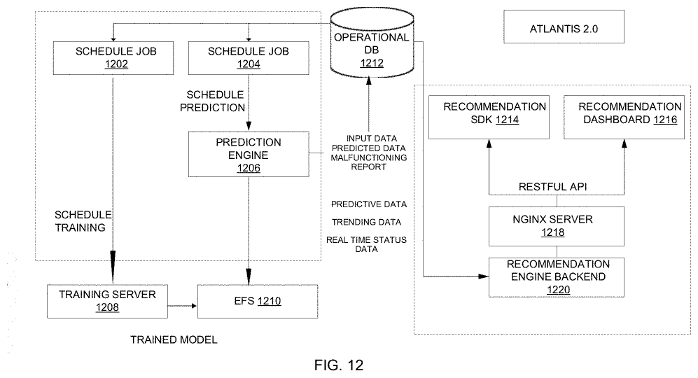

FIG. 12 is an exemplary architecture view of RNN model integration with platform according to an embodiment herein. The view comprises a first schedule 1202, a second schedule 1204, a prediction engine 1206, a training server 1208, an EFS 1210, an operational database 1212, a recommendation software development kit SDK 1214, a recommendation dashboard 1216, a NGINX server 1218 and a recommendation engine 1220. The RNN model is trained periodically with the first schedule 1202. The second schedule 1204 forecasts sensor data on end of predetermined time. For example, every one hour. Predicted and forecasted data is stored in elastic search for serving. The recommendation engine 1220 generates recommendations based on forecasted data which are either used for automation of tasks at urban infrastructure or are displayed on recommendation dashboard 1216.

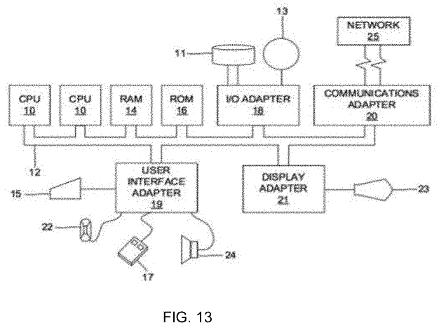

FIG. 13 A representative hardware environment for practicing the embodiments herein is depicted in FIG. 8. This schematic drawing illustrates a hardware configuration of an information handling/computer system in accordance with the embodiments herein. The system comprises one or more processor or central processing unit (CPU) 10. The CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The advantage of the sensor data forecasting system is that it understands and interprets various kind of data accurately leading to robust automation system while handling a huge amount of data generated from large number of sensors covering multiple locations. The system aids in safety, urban management, waste management etc. and provides solutions for urban planning for big and small cities across various parameters in user friendly comprehensive interactive environment.

The foregoing description of the specific embodiments will so fully reveal the general nature of the embodiments herein that others can, by applying current knowledge, readily modify and/or adapt for various applications without departing from the generic concept, and, therefore, such adaptations and modifications should be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A sensor data forecasting system that forecasts sensor data at an urban infrastructure using a deep learning model, the system comprising:
a memory that stores a set of instructions; and
a processor that executes the set of instructions and is configured to
generate a database of a time stamped and indexed sensor data, wherein the sensor data is received from a plurality of sensors implemented in a location;
characterized in that,
determine a false value by analyzing the time stamped and indexed sensor data, wherein the false value is determined based on predetermined parameters that comprise one or more of a constant value, an abnormally high or low value, a false value that is determined to be impossible or improbable, or a calibration error;
determine a category of the false value by analyzing one or more of (a) historical sensor data of a first sensor, (b) comparative sensor data of the first sensor and a second sensor, and (c) comparative sensor data of third sensor and the first sensor, wherein the first, second and third sensors are selected from the plurality of sensors wherein, the first sensor and the second sensor belong to a first sensor type and the third sensor belong to a second sensor type;
determine an imputation method based on the category of the false value, wherein the imputation method employs one or more of (1) a Kalman filter, (2) a nearest neighbor value, (3) a statistical analysis of repeating sensor values of the plurality of sensors;
impute the false value or determine an erroneous sensor from the plurality of sensors;
implement the Kalman filter that determines a sensor variance at each data point of the sensor data to generate optimum sensor value;
forecast sensor data for a subsequent time stamps based on the optimum sensor values as determined at each data point by a trained Recurrent Neural Net (RNN) model; and
perform automation of tasks at the urban infrastructure based on the forecasted sensor data for urban management by generating commands at predetermined events or instances.

2. The sensor data forecasting system of claim 1, wherein the processor executed set of instructions are configured to
receive the sensor data from the plurality of sensors, wherein the sensor data comprise one or more of weather, geo-profile and events data in the location; and
train the Recurrent Neural Net (RNN) model using comparative analysis of the sensor data to identify a false value based on contextual understanding of the sensor data based on a user input.

3. The sensor data forecasting system of claim 1 wherein the processor executed set of instructions are configured to train the RNN model with one or more of (a) the sensor data of a time lag of a predetermined duration, (b) weather data that comprises a temperature, a wind speed, humidity, presence or absence of rain, presence or absence of clouds and luminosity, (c) a presence or absence of a predetermined point of interest that is analyzed using geo-profile of the location, (d) prescheduled events, or (e) sequential events of weekdays or weekends, days of a month, and year.

4. The sensor data forecasting system of claim 1, wherein the processor executed set of instructions are configured to determine a false value indicating the constant value for predetermined threshold number of consecutive time-stamps specific to the sensor type by analyzing historical sensor data.

5. The sensor data forecasting system of claim 1, wherein the processor executed set of instructions are configured to determine the abnormally high or low value as determined by a predetermined threshold values specific to the sensor type.

6. The sensor data forecasting system of claim 1, wherein the processor executed set of instructions are configured to determine the calibration error based on constant higher or lower value readings for a sensor as determined by comparative sensor data analysis.

7. The sensor data forecasting system of claim 1, wherein the processor executed set of instructions are configured to detect abnormal variance of the first sensor by comparative sensor analysis using Levene's test and the first sensor is indicated as an erroneous sensor.

8. The sensor data forecasting system of claim 1, wherein the processor executed set of instructions are configured to impute the sensor data by taking average of a particular time stamp of repeating sensor value over a period of time and replace a false value with the average value for the time stamp.

9. The sensor data forecasting system of claim 1, wherein the processor executed set of instructions are configured to impute the sensor data by replacing a false value by a nearest neighbor value using KNN algorithm.

10. A method of forecasting sensor data at urban infrastructure using a sensor data forecasting system, the method comprising steps of:
generating a database of a time stamped and indexed sensor data, wherein the sensor data is received from a plurality of sensors implemented in a location;
characterized in that,
determining a false value by analyzing the time stamped and indexed sensor data, wherein the false value is determined based on predetermined parameters that comprise one or more of a constant value, an abnormally high or low value, a false value that is determined to be impossible or improbable, or a calibration error;
determining a category of the false value by analyzing one or more of (a) historical sensor data of a first sensor, (b) comparative sensor data of the first sensor and a second sensor, and (c) comparative sensor data of third sensor and the first sensor, wherein the first, second and third sensors are selected from the plurality of sensors wherein, the first sensor and the second sensor belong to a first sensor type and the third sensor belong to a second sensor type;
determining an imputation method based on the category of the false value, wherein the imputation method employs one or more of (1) a Kalman filter, (2) a nearest neighbor value, (3) a statistical analysis of repeating sensor values of the plurality of sensors;
imputing the false value or determine an erroneous sensor from the plurality of sensors;
implementing the Kalman filter that determines a sensor variance at each data point of the sensor data to generate optimum sensor value;
forecasting sensor data for a subsequent time stamps based on the optimum sensor values as determined at each data point by a trained Recurrent Neural Net (RNN) model; and
performing automation of tasks at the urban infrastructure based on the forecasted sensor data for urban management by generating commands at predetermined events or instances.
